(19) United States
(12) Patent Application Publication
(10) Pub. No.: US 2026/0334461 A1
(43) Pub. Date: Oct. 29, 2026

(54) APPARATUS AND SYSTEM FOR PERFUSING AN EX-VIVO LUNG WITHOUT A GAS EXCHANGE DEVICE

(71) Applicant: TransMedics, Inc., Andover, MA (US)

(72) Inventors: Waleed H. HASSANEIN, North Andover, MA (US); Farhan ZAFAR, Andover, MA (US); Amira HASSANEIN, North Andover, MA (US); Mark ANDERSON, Danvers, MA (US); Brian KIMBALL, Medford, MA (US); Paul BIENIEK, Quincy, MA (US); Randy MOSHER, Methuen, MA (US); Christopher PLOTT, Marblehead, MA (US); Ruth SULLIVAN, Lawrence, MA (US); Matthew HOEY, Wakefield, MA (US); Lea WEDDLETON, East Boston, MA (US); Ashley LEVINE, Epping, NH (US)

(21) Appl. No.: 19/655,342

(22) Filed: Apr. 22, 2026

Related U.S. Application Data
(60) Provisional application No. 63/795,157, filed on Apr. 25, 2025.

(51) Int. Cl. A01N 1/143; A01N 1/122

(52) U.S. Cl. CPC A01N 1/143; A01N 1/122

(57) ABSTRACT

Disclosed herein are apparatuses and systems for perfusing an ex-vivo lung, wherein the apparatuses and systems do not use a gas exchange device to affect the gas content of a perfusion fluid. The disclosed systems allow for the ex-vivo lung to deoxygenate perfusion fluid instead of relying on a gas exchange device to do so. Also disclosed are methods for assessing an ex-vivo lung using the disclosed systems.

### CROSS-REFERENCE TO RELATED APPLICATIONS

This application claims priority to U.S. Provisional Application No. 63/795,157, filed Apr. 25, 2025, the entire contents of which are hereby incorporated by reference.

### FIELD OF THE INVENTION

This invention is directed to apparatuses and systems for perfusing an ex-vivo lung, which do not include a gas exchange device. The invention also includes methods for evaluating a lung.

### BACKGROUND OF THE INVENTION

Lung transplantation is a primary therapy for a variety of end-stage lung diseases, such as pulmonary fibrosis, cystic fibrosis, chronic obstructive pulmonary disease, and primary pulmonary hypertension. Lung transplantation has seen significant advancements and innovation in all aspects of the surgical procedures to remove lungs from a donor and implant them in a recipient, and in the pre- and post-operative clinical management of lung transplant recipients. However, most ex-vivo donor lungs are still preserved using cold static storage. Cold storage of donor lungs for transplantation has limitations that can negatively impact utilization and outcomes, such as (1) severe time-dependent injury, which may increase the risk of primary graft dysfunction; (2) the inability to assess organ viability; and (3) the inability to modulate organ condition.

There are portable ex-vivo organ perfusion systems that address the limitation of cold storage by reducing ischemic time through use of warm, oxygenated blood-based perfusion, modulating the lung condition, and allowing for ex-vivo functional assessment. One such system is the TransMedics' Organ Care System (OCS™). There are different OCS™ systems to which different ex-vivo organs can be connected; one such system is for the lungs. The current OCS™ Lung includes a perfusion circuit having a gas exchange device, which can be used in methods for assessing the health of a lung. It is critical to assess the health of the lung for transplant, as poor organ quality can contribute to chronic lung allograft dysfunction. In the existing lung perfusion systems, including the OCS™ Lung, the gas exchange device facilitates the deoxygenation of the perfusion fluid, which subsequently passes through the lungs, allowing for gas exchange by the lungs to oxygenate the perfusate, the partial pressure of oxygen (PO₂) of which can be measured in the perfusate leaving the lungs as an indicator of gas exchange function of the lungs, i.e., quality of the donor lung. However, a gas exchange device is an expensive instrument and adds complexity and costs to manufacturing the lung perfusion system. Furthermore, using a gas exchange device to oxygenate or deoxygenate perfusion fluid can damage blood cells in the perfusion fluid by causing hemolysis. While the removal of a gas exchange device in an ex-vivo lung perfusion system can provide various advantages, the current FDA approved OCS™ Lung Perfusion Module achieves lung oxygenation and deoxygenation via a gas exchange device. As such, there is a need for new and improved apparatuses, methods, and systems for deoxygenating perfusion fluid in a lung perfusion system, as well as new and improved methods and systems for evaluating the quality of donor lungs, e.g., gas exchange function, in the absence of a gas exchange device.

### SUMMARY OF THE INVENTION

The invention generally relates to systems, methods, and devices for ex-vivo organ care. More particularly, the invention relates to apparatuses and systems for evaluating at least one ex-vivo lung that do not include a gas exchange device. The invention also relates to methods for evaluating at least one ex-vivo lung.

In one aspect, the invention includes a system for perfusing an ex-vivo lung including: a perfusion circuit for circulating a perfusion fluid through the ex-vivo lung, the perfusion fluid entering the ex-vivo lung through a pulmonary artery interface and leaving the ex-vivo lung through a left atrial interface, wherein the perfusion circuit does not include a gas exchange device; and a ventilation circuit for flowing a gas into and out of the ex-vivo lung through a tracheal interface, wherein the ventilation circuit is in fluid communication with a ventilation gas and a deoxygenation gas. In some embodiments, the ventilation circuit further includes a gas selector valve coupled to the deoxygenation gas. In some embodiments, the ventilation circuit includes an intake valve that couples ambient air with the ventilation circuit. In some embodiments, the deoxygenation gas includes CO₂ and N₂, e.g., 6% CO₂ and 94% N₂. Meanwhile, the ventilation gas includes ambient air, such as, e.g., 21% O₂.

In some embodiments, the perfusion circuit includes an oxygen probe for measuring an oxygen content of the perfusion fluid before the perfusion fluid enters the ex-vivo lung. In some embodiments, the perfusion circuit includes an oxygen probe for measuring an oxygen content of the perfusion fluid after the perfusion fluid is drained from the ex-vivo lung, e.g., through the left atrial interface.

Furthermore, the system for perfusing the ex-vivo lung can be configured to assess the ex-vivo lung using a lung evaluation mode (e.g., a functional monitoring mode). In some embodiments, the lung evaluation mode includes: deoxygenating the perfusion fluid until a predetermined first value of oxygen content (e.g., 75% oxygen) in the perfusion fluid is reached by ventilating the ex-vivo lung with the deoxygenation gas; and reoxygenating the perfusion fluid by ventilating the ex-vivo lung with the ventilation gas until a predetermined second value of the oxygen content (e.g., 95% oxygen) in the perfusion fluid is reached. In some embodiments, the lung evaluation mode further includes maintaining the perfusion fluid for a hold time (e.g., about 30 seconds) at the predetermined first value of oxygen content before reoxygenating the perfusion fluid.

In some embodiments, the lung evaluation mode further includes determining a condition of the ex-vivo lung includes at least one of: (i) calculating a partial pressure of oxygen in arterial (oxygenated) perfusate (PaO₂)/fractional inspired oxygen value (FiO₂) ratio by dividing an oxygen content of the perfusion fluid measured at a first time (e.g., about two minutes) after deoxygenating the perfusion fluid by an oxygen content of the ventilation gas; (ii) calculating a difference between the oxygen content of the perfusion fluid measured the first time after deoxygenating the perfusion fluid and an oxygen content of the perfusion fluid measured at a second time (e.g., about two to three minutes) after reoxygenating the perfusion fluid; or (iii) calculating an oxygenation time by determining a time taken for the ex-vivo lung to cause the perfusion fluid to reach the predetermined second value of the oxygen content. Furthermore, in some embodiments, the system can include a wireless monitor configured to display the predetermined first value of oxygen content, the predetermined second value of oxygen content, and one or more of (i), (ii), or (iii) on a display screen. In some embodiments, the lung evaluation mode further includes determining a condition of the ex-vivo lung by measuring a time taken to reach the predetermined first value of oxygen content in the perfusion fluid.

In another aspect, the invention includes a method for evaluating an ex-vivo lung including: circulating a perfusion fluid through the ex-vivo lung, the perfusion fluid entering the ex-vivo lung through a pulmonary artery interface and leaving the ex-vivo lung through a left atrial interface; deoxygenating the perfusion fluid by ventilating the ex-vivo lung by flowing a deoxygenation gas through a tracheal interface; and reoxygenating the perfusion fluid by ventilating the ex-vivo lung by flowing a ventilation gas through the tracheal interface. Preferably, the perfusion fluid is deoxygenated without use of a gas exchange device.

In some embodiments, the perfusion fluid is deoxygenated until a predetermined first value of oxygen content (e.g., 75% oxygen) in the perfusion fluid is reached. In some embodiments, the perfusion fluid is reoxygenated until a predetermined second value of the oxygen content (e.g., 95% oxygen) in the perfusion fluid is reached. In some embodiments, the method includes maintaining the perfusion fluid for a hold time (e.g., about 30 seconds) at the predetermined first value of oxygen content before reoxygenating the perfusion fluid.

Furthermore, in some embodiments, the method includes determining a condition of the ex-vivo lung. The condition of the ex-vivo lung can be determined based on at least one of: (i) calculating a PaO₂/FiO₂ ratio by dividing an oxygen content of the perfusion fluid measured at a first time (e.g., about two minutes) after deoxygenating the perfusion fluid by an oxygen content of the ventilation gas; (ii) calculating a difference between the oxygen content of the perfusion fluid measured the first time after deoxygenating the perfusion fluid and an oxygen content of the perfusion fluid measured at a second time (e.g., about two to three minutes) after reoxygenating the perfusion fluid; or (iii) calculating an oxygenation time by determining a time taken for the ex-vivo lung to cause the perfusion fluid to reach the predetermined second value of the oxygen content. In some embodiments, the method includes determining a condition of the ex-vivo lung by measuring a time taken to reach the predetermined first value of oxygen content in the perfusion fluid.

In some embodiments, the method includes using a deoxygenation gas including CO₂ and N₂ (e.g., 6% CO₂ and 94% N₂) to deoxygenate the perfusion fluid. In some embodiments, the method includes using a ventilation gas such as ambient air (e.g., 21% O₂) to reoxygenate the perfusion fluid. Optionally, the method of determining the condition of the ex-vivo lung can be performed more than once. In some embodiments, the condition of the ex-vivo lung is based on comparing (i), (ii), or (iii) for each instance the method is performed.

In another aspect, the invention is directed to a method of perfusing an ex-vivo lung including: circulating a perfusion fluid through the ex-vivo lung, the fluid entering the ex-vivo lung through a pulmonary artery interface and leaving the ex-vivo lung through a left atrial interface; deoxygenating the perfusion fluid until a predetermined first value of oxygen content (e.g., 75% oxygen) in the perfusion fluid is reached by ventilating the ex-vivo lung by flowing a deoxygenation gas through a tracheal interface; maintaining the perfusion fluid at the predetermined first value of oxygen content for a hold time (e.g., about 30 seconds); and reoxygenating the perfusion fluid by ventilating the ex-vivo lung with an oxygenation gas until a predetermined second value of oxygen content (e.g., 95% oxygen) in the perfusion fluid is reached.

In some embodiments, the method includes determining a condition of the ex-vivo lung based on at least one of: (i) calculating a PaO₂/FiO₂ ratio by dividing an oxygen content of the perfusion fluid measured at a first time (e.g., about two minutes) after deoxygenating the perfusion fluid by an oxygen content of the ventilation gas; (ii) calculating a difference between the oxygen content of the perfusion fluid measured the first time after deoxygenating the perfusion fluid and an oxygen content of the perfusion fluid measured at a second time (e.g., about two to three minutes) after reoxygenating the perfusion fluid; or (iii) calculating an oxygenation time by determining a time taken for the ex-vivo lung to cause the perfusion fluid to reach the predetermined second value of the oxygen content. In some embodiments, the method includes determining a condition of the ex-vivo lung by measuring a time taken to reach the predetermined first value of oxygen content in the perfusion fluid. In some embodiments, the perfusion fluid is deoxygenated without use of a gas exchange device.

In some embodiments, the method includes using a deoxygenation gas including CO₂ and N₂ (e.g., 6% CO₂ and 94% N₂) to deoxygenate the perfusion fluid. In some embodiments, the method includes using a ventilation gas such as ambient air (e.g., 21% O₂) to reoxygenate the perfusion fluid. Optionally, the method of determining the condition of the ex-vivo lung can be performed more than once. In some embodiments, the condition of the ex-vivo lung is based on comparing (i), (ii), or (iii) for each instance the method is performed.

In another aspect, the invention includes a system for perfusing an ex-vivo lung comprising: a perfusion circuit for circulating a perfusion fluid through the ex-vivo lung, the perfusion fluid entering the ex-vivo lung through a pulmonary artery interface and leaving the ex-vivo lung through a left atrial interface; and a ventilation circuit for flowing a gas into and out of the ex-vivo lung through a tracheal interface, wherein the ventilation circuit is in fluid communication with a ventilation gas and a deoxygenation gas; wherein the system is configured to operate without a gas exchange device. In some embodiments, the ventilation circuit comprises a gas selector valve coupled to the deoxygenation gas. In some embodiments, the ventilation circuit comprises an intake valve that couples ambient air with the ventilation circuit. In some embodiments, the system is configured to assess the ex-vivo lung using a lung evaluation mode.

In another aspect, the invention includes a system for perfusing an ex-vivo lung comprising: a perfusion circuit for circulating a perfusion fluid through the ex-vivo lung, the perfusion fluid entering the ex-vivo lung through a pulmonary artery interface and leaving the ex-vivo lung through a left atrial interface; and a ventilation circuit for flowing a gas into and out of the ex-vivo lung through a tracheal interface, wherein: the ventilation circuit is in fluid communication with a ventilation gas and a deoxygenation gas, the ventilation circuit comprises a gas selector valve coupled to the deoxygenation gas and an intake valve that couples ambient air with the ventilation circuit, and the system is configured to deoxygenate the perfusion fluid by flowing the deoxygenation gas through the tracheal interface and to oxygenate the perfusion fluid by flowing the ventilation gas through the tracheal interface.

In another aspect, the invention includes a method for perfusing an ex-vivo lung comprising: circulating a perfusion fluid through the ex-vivo lung, the perfusion fluid entering the ex-vivo lung through a pulmonary artery interface and leaving the ex-vivo lung through a left atrial interface; ventilating the ex-vivo lung by flowing a deoxygenation gas through a tracheal interface to deoxygenate the perfusion fluid; and ventilating the ex-vivo lung by flowing a ventilation gas through the tracheal interface to reoxygenate the perfusion fluid.

### BRIEF DESCRIPTION OF THE DRAWINGS

The following figures depict illustrative embodiments of the invention in which like reference numerals refer to like elements. These depicted embodiments may not be drawn to scale and are to be understood as illustrative of the invention and not as limit.

FIG. 1 is a schematic diagram of a perfusion circuit and a ventilation circuit in an ex-vivo lung perfusion system. The perfusion circuit does not include a gas exchange device.

FIG. 2A is a diagram showing an overview of a functional monitoring mode for assessing the health of a lung without a gas exchange device.

FIG. 2B is a diagram showing the timing of the three phases (deoxygenation, hold, and oxygenation) and measurements taken during functional monitoring mode.

FIG. 3A is a diagram showing a pressure waveform and a schematic of the gas flow during the deoxygenation phase of the functional monitoring mode.

FIG. 3B is a diagram showing a pressure waveform during the hold phase of the functional monitoring mode.

FIG. 3C is a diagram showing a pressure waveform and a schematic of the gas flow during the oxygenation phase of the functional monitoring mode.

FIG. 4 is a graph showing the PaO₂/FiO₂ (“P/F”) ratios observed during two trials assessing the health of a lung using the functional monitoring mode described in Example 1.

FIG. 5 is a graph showing the P/F ratios, partial pressure of oxygen in venous (deoxygenated) perfusate (PvO₂), PaO₂, and oxygenation time observed during the study described in Example 2.

FIG. 6 is an image depicting an example of a wireless monitor display compatible with the lung perfusion system described herein.

FIG. 7 is a graph showing the P/F ratios, PvO₂, PaO₂, and oxygenation time observed during the study described in Example 4.

### DETAILED DESCRIPTION

The embodiments described herein provide apparatuses and systems for perfusing a lung, as well as methods for assessing a lung, without the use of a gas exchange device.

### Ex-Vivo Lung Perfusion System Without Gas Exchange Device

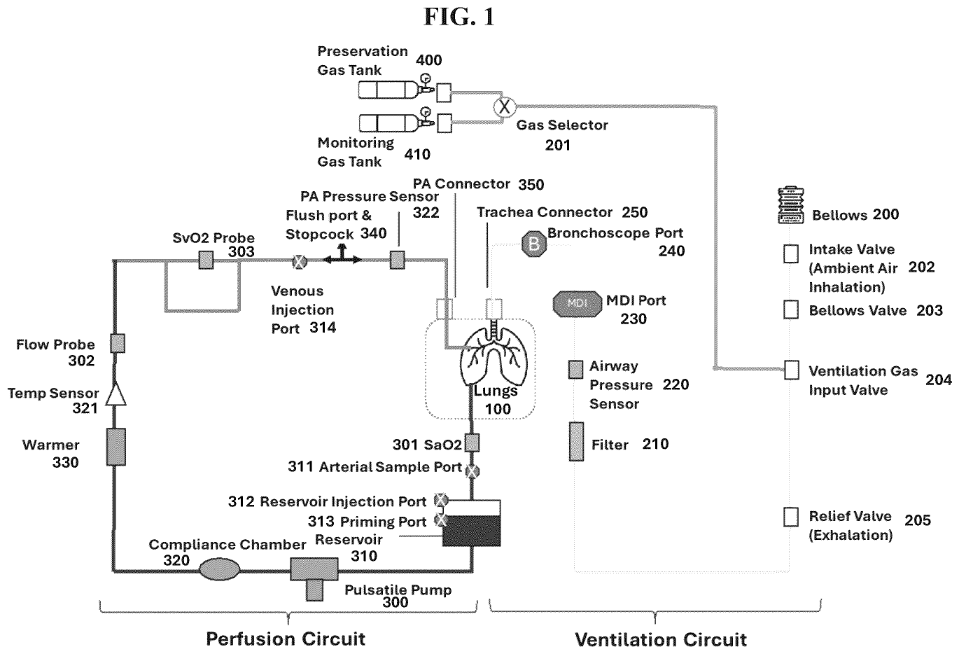

FIG. 1 provides a schematic diagram of the perfusion circuit and the ventilation circuit of an ex-vivo lung perfusion system. The perfusion and ventilation circuits described herein can be used with any suitable lung perfusion module that houses at least one ex-vivo lung and can be configured to connect with the rest of the system. Exemplary ex-vivo lung perfusion systems include those described in, e.g., U.S. Patent Publication No. 2008/0017194 and U.S. Patent Publication No. 2009/0197325, the contents of which are hereby incorporated by reference in their entireties.

The ex-vivo lung perfusion systems disclosed herein can be used for maintaining an ex-vivo lung in a stable condition to allow the lung to be preserved for an extended period of time. In some embodiments, the lung can be maintained according to the maintenance mode described in U.S. Patent Publication No. 2009/0197325. For example, in the maintenance mode described in U.S. Patent Publication No. 2009/0197325, the lungs are ventilated with a gas (e.g., a preservation gas) containing oxygen to meet the lung's metabolic demands as well as carbon dioxide to control the pH of the perfusion fluid. The preservation gas used to ventilate the lungs in maintenance mode may comprise 21% oxygen, 5.5% CO₂, and 73.5% nitrogen. The lungs are ventilated by flowing a captive volume of gas back and forth between the lungs and a bellows, and excess gas is relieved from the circuit to maintain the desired gas pressure in the system. The ex-vivo lung perfusion systems can also be used to assess the health of a lung for transplantation using a functional monitoring mode, which is described in further detail below.

An advantage of the perfusion system disclosed herein is that it does not include a gas exchange device for altering the gas content of the perfusion fluid. Existing ex-vivo lung perfusion systems include a gas exchanger to supplement the function of the lungs and alter the perfusion fluid gas content, e.g., during assessment modes. However, gas exchange devices are expensive. Including a gas exchange device also increases manufacturing costs and complexity of the circuit. In the embodiments described herein, the system can alter the gas content of the perfusion fluid through the lungs and the ventilation circuit, which helps to reduce costs while maintaining the functionality of the perfusion system. The perfusion system disclosed herein can also be used to assess both the oxygenation and deoxygenation capabilities of the lung, which allows for a more comprehensive evaluation of the lung prior to transplantation.

Additionally, the perfusion systems that do not include a gas exchange device as disclosed herein can advantageously avoid damage to the perfusion fluid. Flowing perfusion fluid through a gas exchange device to alter the oxygen content of the perfusion fluid can damage blood cells in the perfusion fluid by causing hemolysis. Removing the gas exchange device reduces the amount of foreign material in contact with the perfusion fluid, which may have a positive impact on the potential for hemolysis, especially for extended perfusion times. Removing the gas exchange device also allows the perfusion system emulate the body ex vivo by mimicking physiological conditions for oxygenating and deoxygenating blood.

### Perfusion Circuit

The perfusion circuit circulates perfusion fluid through the ex-vivo lung's vascular system. The perfusion circuit is not modified when switching between perfusion mode and assessment mode. In a preferred embodiment, the perfusion fluid enters the lung via a cannula inserted into the lung's pulmonary artery (“PA”) and exits the lung from the left atrial (“LA”) interface. A pump (300), in some preferred embodiments a pulsatile pump, causes perfusion fluid to flow around the circuit. The pump (300) receives perfusion fluid from a reservoir (310) and pumps the perfusion fluid through the compliance chamber (320) to the warmer (330). In a preferred embodiment, the circuit includes a compliance chamber (320), which is a flexible portion of tubing that serves to mitigate any pulsatile flow characteristics. The warmer (330) replaces heat lost by the perfusion fluid to the environment during circulation of the fluid. The warmer can heat the perfusion fluid at or near physiologic temperatures, e.g., between about 30 °C to about 37 °C. Preferably, the warmer maintains the perfusion fluid at a temperature of about 30 °C.

After passing through the warmer (330), the perfusion fluid flows directly through a temperature sensor (321), a flow rate probe (302), and a first perfusate oxygen probe (303). The first perfusate oxygen probe (303) measures the amount of oxygen in the perfusion fluid before it enters the lung. This oxygen amount is also referred to as SvO₂, since it is analogous to venous blood oxygen.

The perfusion circuit also includes a venous injection port (314), which facilitates the removal of a perfusate sample or injection of a chemical before the perfusion fluid reaches the lungs. The perfusion fluid then flows through the flush port and stopcock (340) and pulmonary artery (“PA”) pressure sensor (322) before entering the lungs through a cannulated pulmonary artery.

After passing through the lungs, the perfusion fluid exits the lungs from the left atrial interface. The perfusion fluid then flows through a second perfusate oxygen probe (301). The second perfusate oxygen probe (301) measures the amount of oxygen in the perfusion fluid right after it drains from the lung. This amount is also referred to as SaO₂ and is analogous to arterial blood oxygen. Next, the perfusion fluid flows through an arterial sample port (311), a reservoir injection port (312), and a priming port (313) before returning to the reservoir (310).

### Ventilation Circuit

The ventilation circuit ventilates the lungs through the tracheal interface. In a preferred embodiment, the lung is ventilated by compressing a bellows (200), which causes the flow of gas into the lung through a cannula inserted into the trachea. The bellows is regulated by the bellows valve (203). The ventilation circuit also includes an intake valve (202), which allows ambient air into the circuit when open, and a relief valve (205), which allows excess gas to vent from the circuit to maintain a desired pressure level.

Furthermore, the ventilation circuit includes two gas sources, a preservation gas (400) and a monitoring gas (410), coupled with a gas selector (201) to select the desired gas source. The preservation gas (400) can be composed of 21% oxygen, 5.5% CO₂, and 73.5% nitrogen, while the monitoring gas (410) can be composed of 6% CO₂ and 94% nitrogen. The circuit includes a ventilation gas input valve (204) in fluid communication with the preservation gas (400) and the monitoring gas (410), which, when open, allows the gases to be injected into the remainder of the ventilation circuit.

The ventilation circuit also includes an airway pressure sensor (220) for sampling the pressure in the airway of the lungs, a bronchoscope port (240), and a metered dose inhaler (MDI) port (230). The bronchoscope port (240) allows endoscopic examination of the lung's airways, while the MDI port (230) allows injection of drugs into the lungs. Lastly, the circuit includes a filter (210) for filtering the gas before it reaches the lungs.

Optionally, in some embodiments, the lungs can be ventilated by applying a negative pressure to the exterior of the lungs while maintaining a positive pressure in the airway of the lung. This can be used in place of or in addition to using the bellows to ventilate the lung. For example, the lungs may be ventilated by applying a negative pressure according to the systems and methods described in U.S. Patent Publication No. 2020/0329699, the contents of which are hereby incorporated by reference in its entirety.

### Methods of Assessing a Lung Without a Gas Exchange Device

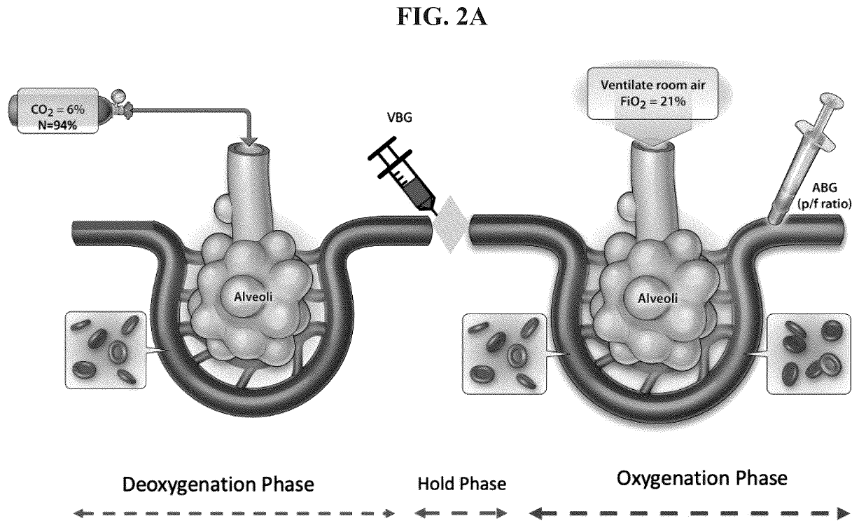

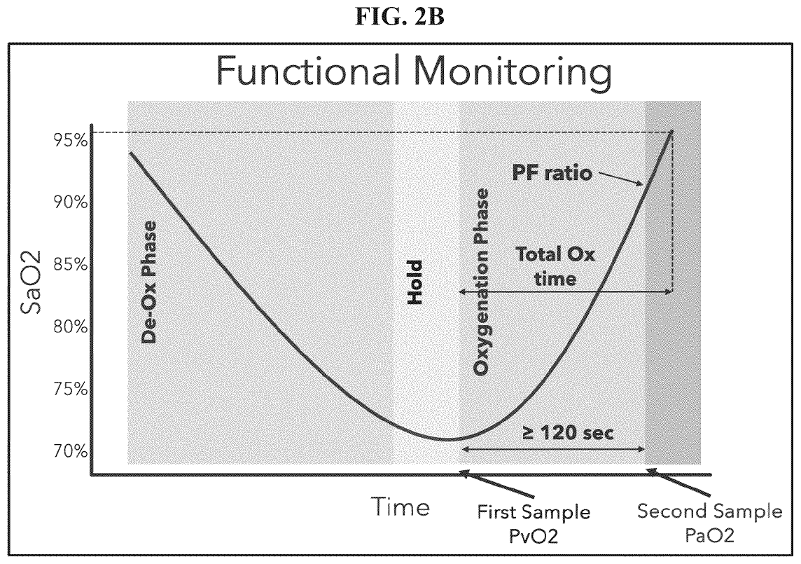

The ex-vivo lung perfusion systems described herein can be configured to assess at least one lung using a functional monitoring mode. The functional monitoring mode tests the gas exchange capability of the lungs by measuring how well the lungs can reoxygenate perfusion fluid. The functional monitoring mode may also be used to assess the lung's capability for deoxygenating perfusion fluid. FIGS. 2A and 2B provide an overview of the functional monitoring mode. The functional monitoring mode includes three phases: (1) a deoxygenation phase, (2) a hold phase, and (3) an oxygenation phase. The oxygen content of the perfusion fluid is sampled after the deoxygenation phase and after the oxygenation phase. Advantageously, the functional monitoring mode can be performed without using a gas exchange device to manipulate the gas content of the perfusion fluid.

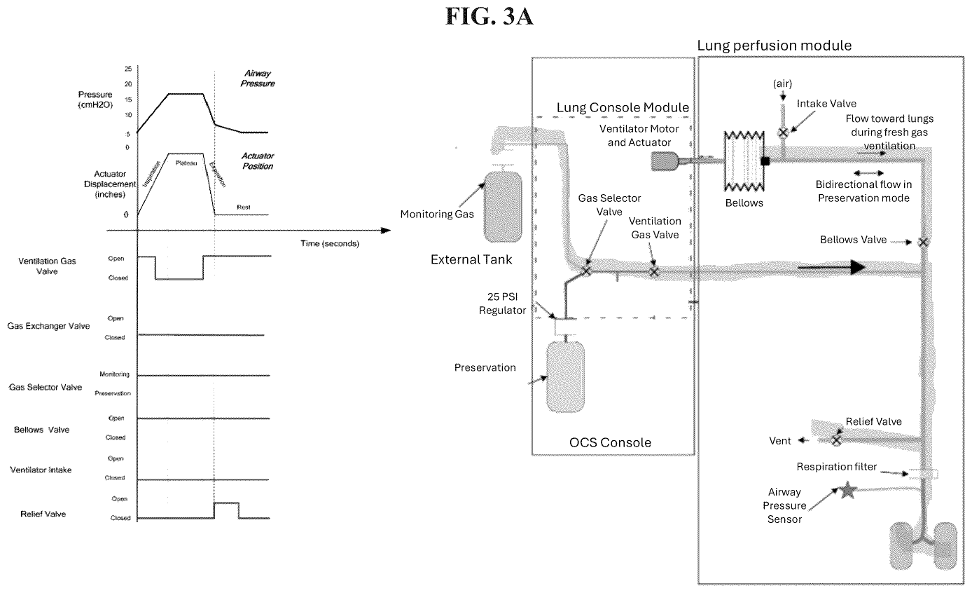

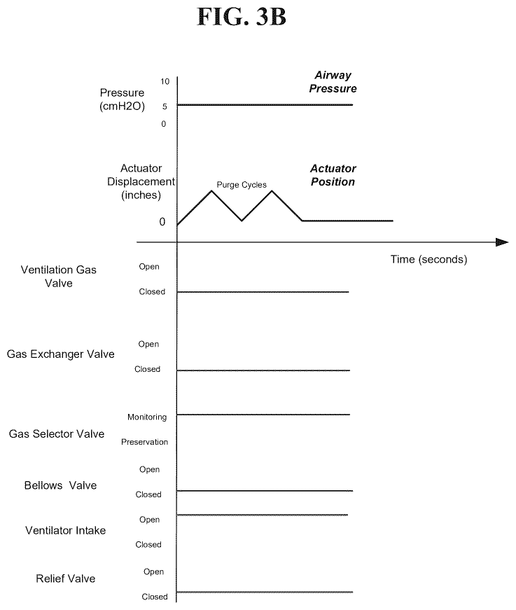

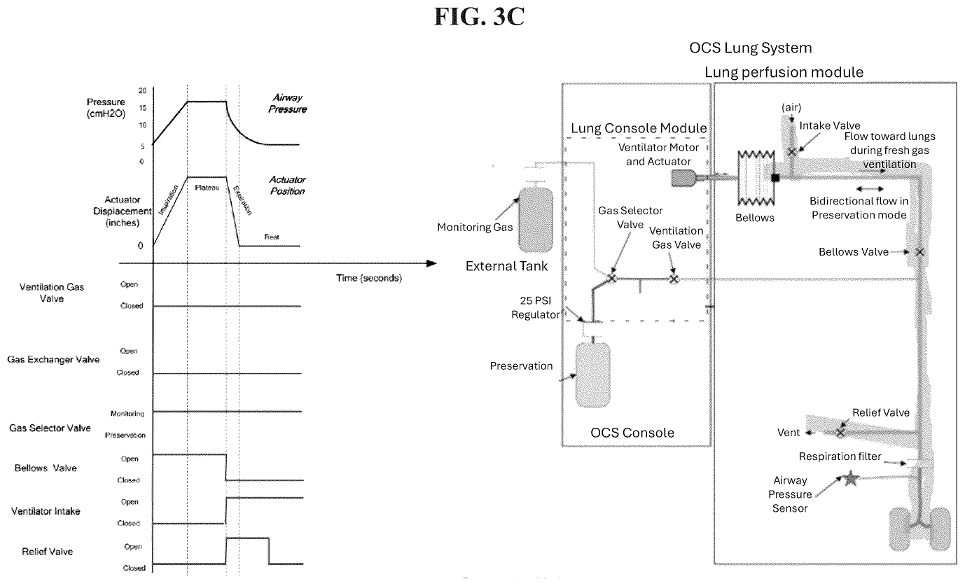

First, the perfusion fluid is deoxygenated during the deoxygenation phase. The goal of the deoxygenation phase is to deoxygenate the blood as quickly as possible. The deoxygenation phase is performed in a closed circuit. As shown in FIG. 3A, during this phase, the gas selector (201) is set to monitoring gas (410) and the intake valve (202) is closed. The ventilation gas input valve (204) is open and allows the monitoring gas (410) to enter into the ventilation circuit. By ventilating the lung with the monitoring gas (410), the lung can deoxygenate the perfusion fluid until the perfusion fluid reaches a set threshold of oxygen saturation. For instance, the oxygen threshold can be set to about 75%. The lung deoxygenates the perfusion fluid by effectuating gas exchange between the inspired gas and perfusion fluid such that the concentration of oxygen in the perfusion fluid is balanced with the concentration of oxygen in the ventilation gas, i.e., the monitoring gas (410) during this phase. Since the monitoring gas (410) has no oxygen during this process, the lungs will reduce the oxygen content of the perfusion fluid until the gas content of the perfusion fluid reaches the set threshold of oxygen saturation. During the deoxygenation phase, the flow rate during lung inspiration is at the maximum rate of 1000 mL/min, and flow continues through the expiration and rest phases. Advantageously, the lung can be assessed for its deoxygenation capabilities during the deoxygenation phase. The efficiency of the lung can be determined by monitoring the time taken for the lung to achieve the 75% oxygen threshold, with a faster deoxygenation time corresponding to better efficiency. For example, lungs that are capable of reaching the 75% oxygen threshold within 2 minutes are considered to be healthy, while lungs that are not may be further assessed to determine their suitability for transplant.

After reaching the set oxygen threshold, the functional monitoring mode proceeds to the hold phase. During the hold phase (depicted in FIG. 3B), the deoxygenation process is halted by closing the ventilation gas input valve (204) such that deoxygenation gas is no longer introduced into the circuit, while the perfusion fluid continues to flow through the lungs. This allows the SaO₂ and SvO₂ levels of the perfusion fluid to settle. The hold phase can be maintained for a set period of time that can be configured by a user of the ex-vivo lung perfusion system. For example, the set period of time can be about 30 seconds. There is no respiration cycle during the hold phase, and the lung airway pressure is held at a user-defined peak end expiratory pressure (PEEP) level while deoxygenation gas is purged from the bellows (200). The purge is necessary so that the oxygenation phase can begin with a breath of fresh air that does not include any deoxygenation gas, which could lead to an inaccurate assessment. The purge is accomplished by compressing and expanding the bellows (200) with the intake valve (202) opened and the bellows valve (203) closed.

Finally, during the oxygenation phase, the lungs reoxygenate the perfusion fluid. The goal of the oxygenation phase is for the lungs to oxygenate the blood supply as quickly as they can. As shown in FIG. 3C, the ventilation gas input valve (204) is now closed to prevent monitoring gas (410) from entering into the ventilation circuit. Instead, the intake valve (202) is open to allow ambient air into the circuit. The ambient air has an oxygenation level of about 21% FiO₂ (fractional inspired oxygen). The lungs reoxygenate the perfusion fluid by breathing in the ambient air, and the system measures the time for the perfusion fluid to rise from a lower set oxygenation saturation threshold (default=about 76%) to an upper set oxygen saturation threshold (default=about 95%).

The functional assessment mode allows the user to assess the health of the lung by measuring the following:
1. The ratio of PaO₂/FiO₂ (“P/F ratio”) on 21% fractional inspired oxygen value (FiO₂) taken, e.g., 2 minutes after initiation of the oxygenation phase. PaO₂ refers to the partial pressure of oxygen in arterial (oxygenated) perfusate.
2. A comparison of blood gas measurements taken during the hold phase (i.e., peak desaturation), which provides an assessment of venous pO₂, and taken after 2-3 minutes of oxygenation, which provides an assessment of arterial pO₂. The difference in pO₂ between venous blood and arterial blood will reflect the efficiency of oxygenation by the lung. A larger difference indicates better lung quality.
3. The time required to achieve an outflow (left atrial blood) oxygen saturation to a preset saturation target within the 3 minutes of assessment. This time is referred to as the oxygenation time or “Ox time.” The trend in Ox time can be used to evaluate lung quality over time.

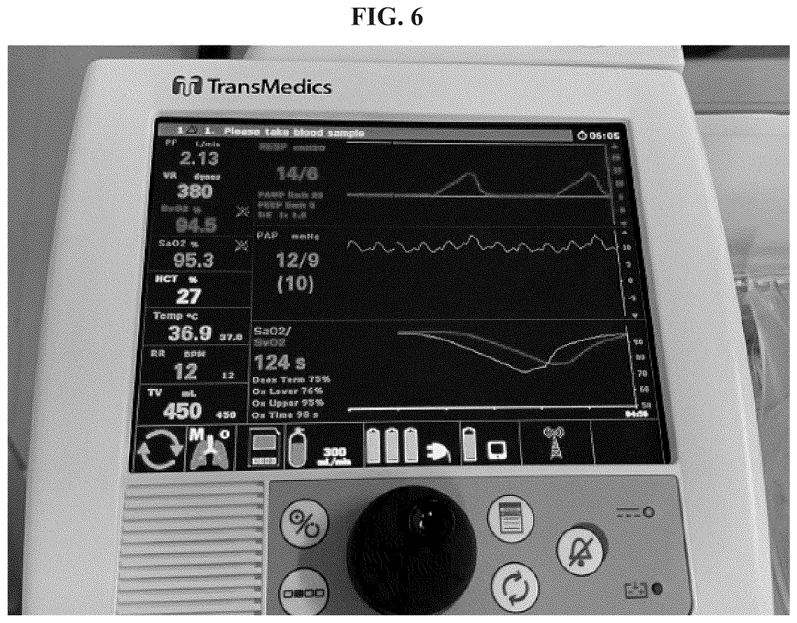

The health of the lung can also be assessed over time by performing the functional assessment mode at least twice and reviewing the trends in any one of (1)-(3). The assessment can be repeated as many times as needed based on the duration of the lung preservation. The settings used to assess the lung and information collected during the functional monitoring mode can optionally be displayed on a wireless monitor. FIG. 6 provides an example of a wireless monitor displaying information regarding the functional assessment mode.

### EXAMPLES

The following non-limiting examples are provided to illustrate the present disclosure.

### Example 1

A study was performed to assess the health of an ex-vivo lung. Double lungs were harvested from a swine model and flushed with perfusion solution. The lungs were then prepared, cannulated, and instrumented on TransMedics' OCS™ Lung modified to exclude a gas exchange device as described herein. The lungs were then assessed using the functional monitoring mode as described above. Functional monitoring was performed at the following perfusion times: 1 hour, 3 hours, 6 hours, and 8 hours. The lung function was monitored by taking perfusate samples. The perfusate samples were taken to assess PaO₂ (partial pressure of oxygen in arterial (oxygenated) perfusate), PvO₂ (partial pressure of oxygen in venous (deoxygenated) perfusate), arterial pH, venous pH, SaO₂, and SvO₂. The P/F ratio was also calculated. The data taken for each sample were entered into the OCS™ software user interface through the blood sample menu.

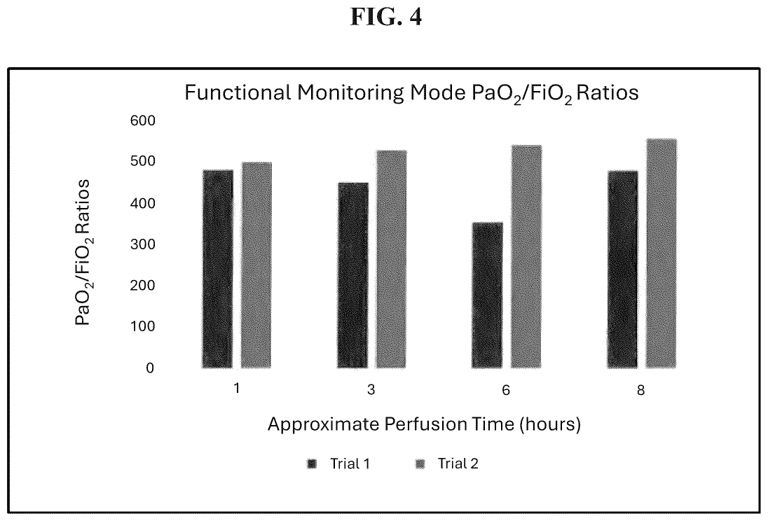

During functional monitoring mode, the lungs were tested for their oxygenation capacity at all time points of preservation by perfusing with perfusate at a venous saturation (i.e., oxygen saturation of 75%) and monitoring the arterial saturation. The lungs were observed over 2-3 minutes to assess their ability to oxygenate the perfusate to an arterial saturation that exceeds 95% oxygen saturation. The time taken to reach the arterial saturation rate is referred to as the oxygenation time (“Ox time”). The oxygenation time results are provided in Table 1 below. The pH, PaO₂, and P/F ratios measured at each time point is provided in Table 2. Table 2 shows that the arterial pH ranged from 7.328-7.507 for both experiments, and that blood was well-oxygenated by the lungs as evidenced by the PaO₂. The P/F ratios are also shown in FIG. 4. Good lung function (i.e., P/F>300) was observed at all time points.

TABLE 1
Oxygenation time (seconds) during functional monitoring mode

| | | Time point | | | | |
|---|---|---|---|---|---|---|
| Trial | Parameter | 1 hour | 3 hours | 6 hours | 8 hours | Mean ± SD |
| 1 | Oxygenation time (sec) | 180 | 180 | 180 | 44 | 171 ± 18 |
| 2 | Oxygenation time (sec) | 117 | 117 | 115 | 105 | 114 ± 6 |

TABLE 2
Functional monitoring mode - arterial parameters (radiometer)

| | | Time point | | | | |
|---|---|---|---|---|---|---|
| Trial | Parameter | 1 hour | 3 hours | 6 hours | 8 hours | Mean ± SD |
| 1 | pH | 7.40 | 7.328 | 7.412 | 7.395 | 7.384 ± 0.038 |
| | PaO₂ (mmHg) | 101 | 94.8 | 74.6 | 101 | 92.9 ± 12.5 |
| | PaO₂/FiO₂ ratio | 480.9 | 451.4 | 355.2 | 480 | 441.9 ± 59.4 |
| 2 | pH | 7.507 | 7.506 | 7.425 | 7.491 | 7.482 ± 0.039 |
| | PaO₂ (mmHg) | 105 | 111 | 114 | 117 | 112 ± 5.0 |
| | PaO₂/FiO₂ ratio | 500 | 528.5 | 542 | 557 | 531.9 ± 24.2 |

The results demonstrate that ex-vivo lungs are successfully assessed using the functional monitoring mode, which does not require the ex-vivo lung perfusion system to include a gas exchange device.

### Example 2

A study was conducted to demonstrate the pre-clinical benefit of using an ex-vivo lung perfusion system for prolonged ex-vivo perfusion and ventilation over 21 hours of perfusion using a modified OCS™ Lung that does not include a gas exchange device. Large swine (>90 kg pigs) donor lung pairs were used as the study model.

Four pairs of swine lungs were assessed using the functional monitoring mode. Functional monitoring was conducted at least two times during the first 5 to 6 hours of perfusion. A final assessment is also conducted close to the end of perfusion, with a minimum perfusion duration time of 21 hours. For each functional monitoring assessment, two perfusate samples were taken from the left atrial port: first, at peak desaturation marked by the hold phase to determine PvO₂ measurement; and second, after 120 seconds of the reoxygenation phase to determine PaO₂ measurement. The phases of the functional monitoring mode are depicted in FIG. 2B.

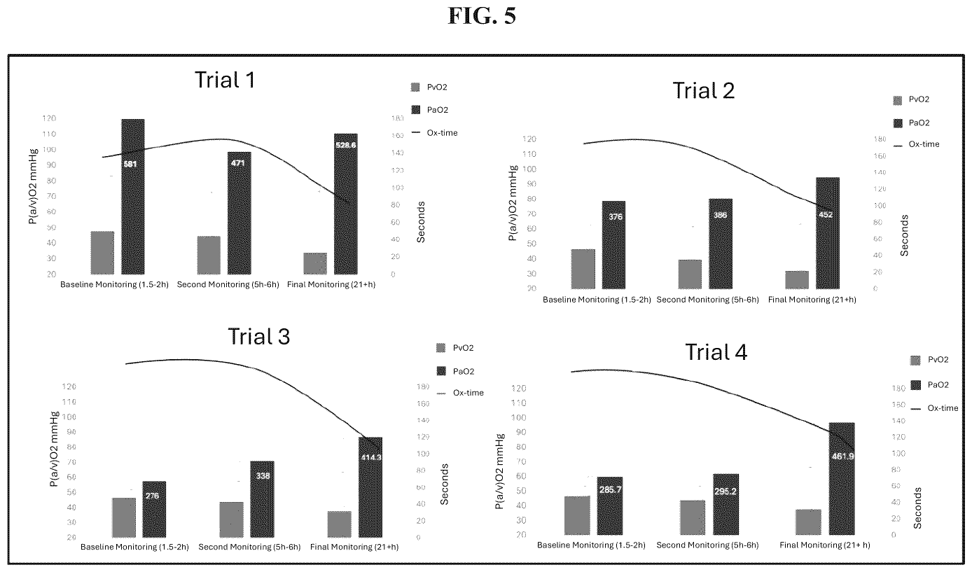

A summary of the trends in parameters for the four trials observed during the functional monitoring mode is presented in Table 3 below. Trends of P/F ratios, PvO₂/PaO₂ differential, and oxygenation time (“Ox time”) over prolonged perfusion are depicted in FIG. 5. As shown in Table 3, the vascular resistance, pulmonary artery pressure, and peak airway pressure were trending down at the same pump flow and ventilation settings throughout the perfusion session. The downward trend in the perfusion and ventilation parameters assessed at the same pump flow indicates an improvement in lung function over time. This improvement is also reflected in the improved P/F ratio and oxygenation time over the course of preservation depicted in FIG. 5.

TABLE 3
Summary of the Trends of Parameters at 120 sec in the
Oxygenation Phase of the Functional Monitoring Mode

| | | | | Pulmonary | | | Peak | |
|---|---|---|---|---|---|---|---|---|
| | | | Vascular | Artery | | | Airway | |
| | Perfusion | Pump | Resistance | Pressure | | | Pressure | |
| | time | flow | (VR) | (PAP) | | | (PAWP) | Ox Time |
| | (hh:mm) | (L/min) | (dynes/cm⁵) | (mmHg) | SvO₂%* | SaO₂% | (cmH₂O) | (sec)** |
| 1 | 1:25 | 2.18 | 510 | 14 | 90.5 | 94.5 | 15 | 118 |
| | 6:10 | 2.02 | 400 | 10 | 89.1 | 94.1 | 14 | 141 |
| | 22:19 | 2.2 | 250 | 7 | 93.3 | 95.9 | 12 | 72 |
| 2 | 2:05 | 2.19 | 400 | 11 | 85.6 | 91.3 | 13 | — |
| | 6:05 | 2.1 | 340 | 9 | 87.9 | 93.3 | 15 | 123 |
| | 22:16 | 2.15 | 300 | 8 | 91.8 | 95.7 | 14 | 90 |
| 3 | 2:06 | 2.13 | 530 | 14 | 80.9 | 85.5 | 16 | — |
| | 4:58 | 2.14 | 410 | 11 | 84.7 | 90.1 | 16 | — |
| | 21:41 | 2.15 | 300 | 8 | 90.4 | 94.9 | 13 | 100 |
| 4 | 2:24 | 2.03 | 360 | 9 | 81.3 | 85.6 | 18 | — |
| | 5:53 | 2.15 | 300 | 8 | 84.5 | 88.3 | 17 | — |
| | 22:00 | 2.16 | 300 | 8 | 91.5 | 94.8 | 13 | 108 |

*SvO₂ in the monitoring summary was captured during 120 seconds of oxygenation.
**The functional monitoring allows 180 seconds for oxygenation and if the SaO₂ threshold of 95% was not achieved by 180 seconds, the functional monitoring mode automatically switches to a preservation mode and ox-time is measured as -- (>180 seconds).

In all studies, the P/F ratio improved over time during perfusion on the OCS™ Lung modified to exclude a gas exchange device. All final P/F ratios on 21% FiO₂ were >400 as depicted in FIG. 5. As the differential (PaO₂−PvO₂) increased over time, the ox time decreased in parallel indicating improvement of the oxygenation capacity of the perfused lungs. These results therefore demonstrate that an ex-vivo lung perfusion system that does not include a gas exchange device can be successfully used to perfuse a lung and to assess the health of the lung.

### Example 3

Five tests were performed using porcine lungs and a prototype design of a lung perfusion module that does not include a gas exchange device according to an embodiment described herein. The prototype lung perfusion module was used to replace the lung perfusion module including a gas exchange device within TransMedics' OCS™ Lung. Testing was performed for 24 hours under normal clinical conditions and with lungs in the supine position (similar to if a patient were to lay on their back), with at least the final 1 hour in the proned position (similar to if a patient were to lay on their face, i.e., with the anterior surface of the lung face down towards the support surface). Normal clinical conditions mimic physiological flow and pressures. These conditions include a mean pulmonary artery pressure (PAP) of <20 mm Hg; normal volume controlled ventilation with a peak airway pressure of <25 cm H₂O; and peak end expiratory pressure (PEEP) maintained throughout preservation (i.e., not <5 cm H₂O).

The lungs were assessed at about 2 hours (initial assessment) and about 24 hours (final assessment) using the functional monitoring mode. During the functional monitoring mode, a monitoring gas was used to deoxygenate the lungs to a saturation of 65% O₂, and then room air was used to reoxygenate the lungs according to the embodiments disclosed herein. The oxygenation time was calculated based on the time for the O₂ saturation to increase from 73% to 93%, with lower times indicating better oxygenation ability. The oxygenation time for lung 5 was not recorded, as these lungs were determined to be “bad lungs” at the beginning of the study. The recorded oxygenation times are provided in Table 4 below.

TABLE 4
Oxygenation Time

| | Ox Time | Ox Time | |
|---|---|---|---|
| | (seconds) | (seconds) | Ox Time |
| | Initial | Final | Improvement |
| Lung | Assessment | Assessment | (seconds) |
| 1 | 53 | 31 | 22 seconds |
| 2 | 91 | 50 | 41 seconds |
| 3 | 113 | 87 | 26 seconds |
| 4 | 50 | 26 | 24 seconds |
| 5 | Not Recorded | Not Recorded | Not Recorded |

The P/F ratios were also calculated, which is shown in Table 5 below. The P/F ratio indicates the lung oxygenation capability when challenged, with a score of 400 considered as “passing.” As shown in Table 4, lung 5 showed a dramatic decrease in P/F ratio after preservation, which corresponded to the fact that these lungs were already determined to be “bad lungs.”

TABLE 5
P/F Ratios

| | P/F Ratio | P/F Ratio | |
|---|---|---|---|
| | Initial | Final | Change in |
| Lung | Assessment | Assessment | P/F Ratio |
| 1 | 448 | 400 | −48 |
| 2 | 466 | 434 | −32 |
| 3 | 372 | 431 | +59 |
| 4 | 449 | 394 | −55 |
| 5 | 418 | 273 | −145 |

The results demonstrate that the ex-vivo lungs were successfully assessed using the functional monitoring mode with the lung perfusion module modified to not include a gas exchange device.

### Example 4

A study was conducted to demonstrate the pre-clinical benefit of using an ex-vivo lung perfusion system for prolonged ex-vivo perfusion and ventilation over 21 hours of perfusion using a modified OCS™ Lung that does not include a gas exchange device. Large swine (>90 kg pigs) donor lung pairs were used as the study model.

Four pairs of swine lungs were assessed using the functional monitoring mode. Functional monitoring was conducted at least two times during the first 5 to 6 hours of perfusion. A final assessment is also conducted close to the end of perfusion, with a minimum perfusion duration time of 21 hours. For each functional monitoring assessment, two perfusate samples were taken from the left atrial port: first, at peak desaturation marked by the hold phase to determine PvO₂ measurement; and second, after 120 seconds of the reoxygenation phase to determine PaO₂ measurement. The phases of the functional monitoring mode are depicted in FIG. 2B.

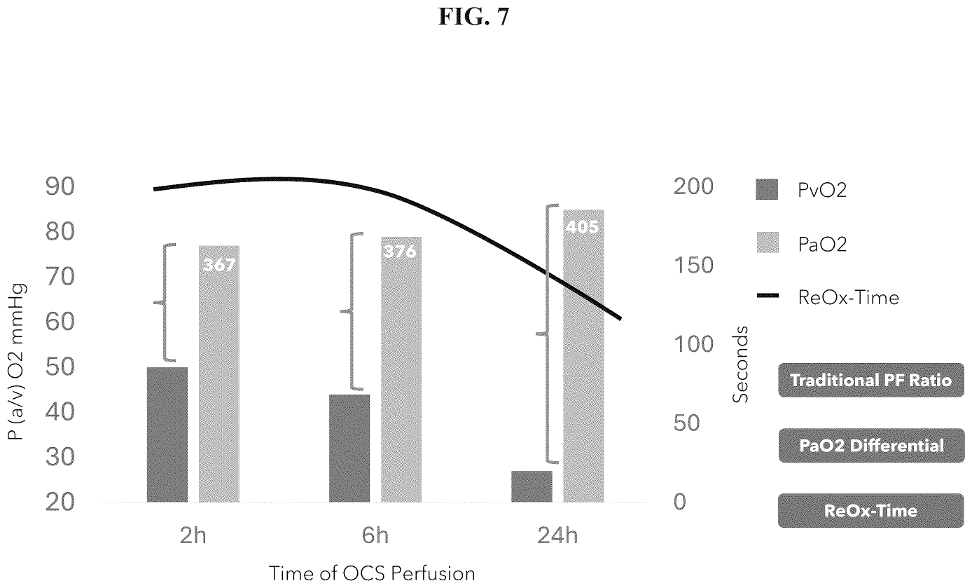

Trends of P/F ratios, PvO₂/PaO₂ differential, and Ox time over prolonged perfusion are depicted in FIG. 7. The P/F ratio improved over time during perfusion on the OCS™ Lung modified to exclude a gas exchange device. The final P/F ratio was >400 as depicted in FIG. 7. As the differential (PaO₂−PvO₂) increased over time, the ox time decreased in parallel indicating improvement of the oxygenation capacity of the perfused lungs. These results therefore demonstrate that an ex-vivo lung perfusion system that does not include a gas exchange device can be successfully used to perfuse a lung and to assess the health of the lung.

What is claimed is:

1. A system for perfusing an ex-vivo lung comprising:
a perfusion circuit for circulating a perfusion fluid through the ex-vivo lung, the perfusion fluid entering the ex-vivo lung through a pulmonary artery interface and leaving the ex-vivo lung through a left atrial interface, wherein the perfusion circuit does not comprise a gas exchange device; and
a ventilation circuit for flowing a gas into and out of the ex-vivo lung through a tracheal interface, wherein the ventilation circuit is in fluid communication with a ventilation gas and a deoxygenation gas.

2. The system of claim 1, wherein the ventilation circuit comprises a gas selector valve coupled to the deoxygenation gas.

3. The system of claim 1, wherein the ventilation circuit comprises an intake valve that couples ambient air with the ventilation circuit.

4. The system of claim 1, wherein the deoxygenation gas comprises CO₂ and N₂.

5. The system of claim 1, wherein the deoxygenation gas comprises 6% CO₂ and 94% N₂.

6. The system of claim 1, wherein the ventilation gas is ambient air.

7. The system of claim 1, wherein the ventilation gas comprises 21% O₂.

8. The system of claim 1, wherein the perfusion circuit comprises an oxygen probe for measuring an oxygen content of the perfusion fluid before the perfusion fluid enters the ex-vivo lung.

9. The system of claim 1, wherein the perfusion circuit comprises an oxygen probe for measuring an oxygen content of the perfusion fluid after the perfusion fluid is drained from the ex-vivo lung.

10. The system of claim 1, wherein the system is configured to assess the ex-vivo lung using a lung evaluation mode.

11. The system of claim 10, wherein the lung evaluation mode comprises:
deoxygenating the perfusion fluid until a predetermined first value of oxygen content in the perfusion fluid is reached by ventilating the ex-vivo lung with the deoxygenation gas; and
reoxygenating the perfusion fluid by ventilating the ex-vivo lung with the ventilation gas until a predetermined second value of the oxygen content in the perfusion fluid is reached.

12. The system of claim 1, wherein the predetermined first value of oxygen content is 75% oxygen.

13. The system of claim 1, wherein the predetermined second value of oxygen content is 95% oxygen.

14. The system of claim 11, wherein the lung evaluation mode further comprises maintaining the perfusion fluid for a hold time at the predetermined first value of oxygen content before reoxygenating the perfusion fluid.

15. The system of claim 14, wherein the hold time is about 30 seconds.

16. The system of claim 11, wherein the lung evaluation mode further comprises determining a condition of the ex-vivo lung comprises at least one of:
(i) calculating a PaO₂/FiO₂ ratio by dividing an oxygen content of the perfusion fluid measured at a first time after deoxygenating the perfusion fluid by an oxygen content of the ventilation gas;
(ii) calculating a difference between the oxygen content of the perfusion fluid measured the first time after deoxygenating the perfusion fluid and an oxygen content of the perfusion fluid measured at a second time after reoxygenating the perfusion fluid; or
(iii) calculating an oxygenation time by determining a time taken for the ex-vivo lung to cause the perfusion fluid to reach the predetermined second value of the oxygen content.

17. The system of claim 16, wherein the first time after deoxygenating the perfusion fluid is about two minutes.

18. The system of claim 16, wherein the second time after reoxygenating the perfusion fluid is about two to three minutes.

19. The system of claim 16, further comprising a wireless monitor configured to display the predetermined first value of oxygen content, the predetermined second value of oxygen content, and one or more of (i), (ii), or (iii) on a display screen.

20. The system of claim 11, wherein the lung evaluation mode further comprises determining a condition of the ex-vivo lung by measuring a time taken to reach the predetermined first value of oxygen content in the perfusion fluid.

21. A method for evaluating an ex-vivo lung comprising:
circulating a perfusion fluid through the ex-vivo lung, the perfusion fluid entering the ex-vivo lung through a pulmonary artery interface and leaving the ex-vivo lung through a left atrial interface;
deoxygenating the perfusion fluid by ventilating the ex-vivo lung by flowing a deoxygenation gas through a tracheal interface; and
reoxygenating the perfusion fluid by ventilating the ex-vivo lung by flowing a ventilation gas through the tracheal interface.

22. The method of claim 21, wherein the perfusion fluid is deoxygenated without use of a gas exchange device.

23. The method of claim 21, wherein the perfusion fluid is deoxygenated until a predetermined first value of oxygen content in the perfusion fluid is reached.

24. The method of claim 21, wherein the perfusion fluid is reoxygenated until a predetermined second value of the oxygen content in the perfusion fluid is reached.

25. The method of claim 23, wherein the predetermined first value of oxygen content is 75% oxygen.

26. The method of claim 24, wherein the predetermined second value of oxygen content is 95% oxygen.

27. The method of claim 21, further comprising maintaining the perfusion fluid for a hold time at the predetermined first value of oxygen content before reoxygenating the perfusion fluid.

28. The method of claim 27, wherein the hold time is about 30 seconds.

29. The method of claim 21, further comprising determining a condition of the ex-vivo lung.

30. The method of claim 29, wherein determining the condition of the ex-vivo lung comprises at least one of:
(i) calculating a PaO₂/FiO₂ ratio by dividing an oxygen content of the perfusion fluid measured at a first time after deoxygenating the perfusion fluid by an oxygen content of the ventilation gas;
(ii) calculating a difference between the oxygen content of the perfusion fluid measured the first time after deoxygenating the perfusion fluid and an oxygen content of the perfusion fluid measured at a second time after reoxygenating the perfusion fluid; or
(iii) calculating an oxygenation time by determining a time taken for the ex-vivo lung to cause the perfusion fluid to reach the predetermined second value of the oxygen content.

31. The method of claim 21, wherein the deoxygenation gas comprises CO₂ and N₂.

32. The method of claim 21, wherein the deoxygenation gas comprises 6% CO₂ and 94% N₂.

33. The method of claim 21, wherein the ventilation gas is ambient air.

34. The method of claim 21, wherein the ventilation gas comprises 21% O₂.

35. The method of claim 30, wherein the method of determining the condition of the ex-vivo lung is performed more than once.

36. The method of claim 35, wherein the condition of the ex-vivo lung is based on comparing (i), (ii), or (iii) for each instance the method is performed.

37. The method of claim 25, further comprising determining a condition of the ex-vivo lung by measuring a time taken to reach the predetermined first value of oxygen content in the perfusion fluid.

38. A method of perfusing an ex-vivo lung comprising:
circulating a perfusion fluid through the ex-vivo lung, the fluid entering the ex-vivo lung through a pulmonary artery interface and leaving the ex-vivo lung through a left atrial interface;
deoxygenating the perfusion fluid until a predetermined first value of oxygen content in the perfusion fluid is reached by ventilating the ex-vivo lung by flowing a deoxygenation gas through a tracheal interface;
maintaining the perfusion fluid at the predetermined first value of oxygen content for a hold time; and
reoxygenating the perfusion fluid by ventilating the ex-vivo lung with an oxygenation gas until a predetermined second value of oxygen content in the perfusion fluid is reached.

39. The method of claim 38, further comprising determining a condition of the ex-vivo lung comprises at least one of:
(i) calculating a PaO₂/FiO₂ ratio by dividing an oxygen content of the perfusion fluid measured at a first time after deoxygenating the perfusion fluid by an oxygen content of the ventilation gas;
(ii) calculating a difference between the oxygen content of the perfusion fluid measured the first time after deoxygenating the perfusion fluid and an oxygen content of the perfusion fluid measured at a second time after reoxygenating the perfusion fluid; or
(iii) calculating an oxygenation time by determining a time taken for the ex-vivo lung to cause the perfusion fluid to reach the predetermined second value of the oxygen content.

40. The method of claim 38, wherein the perfusion fluid is deoxygenated without use of a gas exchange device.

41. The method of claim 38, wherein the predetermined first value of oxygen content is 75% oxygen.

42. The method of claim 38, wherein the predetermined second value of oxygen content is 95% oxygen.

43. The method of claim 38, wherein the hold time is about 30 seconds.

44. The method of claim 38, wherein the deoxygenation gas comprises CO₂ and N₂.

45. The method of claim 38, wherein the deoxygenation gas comprises 6% CO₂ and 94% N₂.

46. The method of claim 38, wherein the ventilation gas is ambient air.

47. The method of claim 38, wherein the ventilation gas comprises 21% O₂.

48. The method of claim 39, wherein the method of determining the condition of the ex-vivo lung is performed more than once.

49. The method of claim 48, wherein the condition of the ex-vivo lung is based on comparing (i), (ii), or (iii) for each instance the method is performed.

50. The method of claim 38, further comprising determining a condition of the ex-vivo lung by measuring a time taken to reach the predetermined first value of oxygen content in the perfusion fluid.

51. A system for perfusing an ex-vivo lung comprising:
a perfusion circuit for circulating a perfusion fluid through the ex-vivo lung, the perfusion fluid entering the ex-vivo lung through a pulmonary artery interface and leaving the ex-vivo lung through a left atrial interface; and
a ventilation circuit for flowing a gas into and out of the ex-vivo lung through a tracheal interface, wherein the ventilation circuit is in fluid communication with a ventilation gas and a deoxygenation gas;
wherein the system is configured to operate without a gas exchange device.

52. The system of claim 51, wherein the ventilation circuit comprises a gas selector valve coupled to the deoxygenation gas.

53. The system of claim 51, wherein the ventilation circuit comprises an intake valve that couples ambient air with the ventilation circuit.

54. The system of claim 51, wherein the system is configured to assess the ex-vivo lung using a lung evaluation mode.

55. A system for perfusing an ex-vivo lung comprising:
a perfusion circuit for circulating a perfusion fluid through the ex-vivo lung, the perfusion fluid entering the ex-vivo lung through a pulmonary artery interface and leaving the ex-vivo lung through a left atrial interface; and
a ventilation circuit for flowing a gas into and out of the ex-vivo lung through a tracheal interface, wherein:
the ventilation circuit is in fluid communication with a ventilation gas and a deoxygenation gas,
the ventilation circuit comprises a gas selector valve coupled to the deoxygenation gas and an intake valve that couples ambient air with the ventilation circuit, and
the system is configured to deoxygenate the perfusion fluid by flowing the deoxygenation gas through the tracheal interface and to oxygenate the perfusion fluid by flowing the ventilation gas through the tracheal interface.

56. A method for perfusing an ex-vivo lung comprising:
circulating a perfusion fluid through the ex-vivo lung, the perfusion fluid entering the ex-vivo lung through a pulmonary artery interface and leaving the ex-vivo lung through a left atrial interface;
ventilating the ex-vivo lung by flowing a deoxygenation gas through a tracheal interface to deoxygenate the perfusion fluid; and
ventilating the ex-vivo lung by flowing a ventilation gas through the tracheal interface to reoxygenate the perfusion fluid.
